(19) United States
(12) Patent Application Publication
(10) Pub. No.: US 2002/0152098 A1
(43) Pub. Date: Oct. 17, 2002

(54) System and method for facilitating interaction with a financial service

(76) Inventors: Bret A. Evans, Overland Park, KS (US); Peter G. Jaisle, Leawood, KS (US)

Correspondence Address: Jennifer A. Albert, Esq., Hunton & Williams, Suite 1200, 1900 K Street, N.W., Washington, DC, 20006, US

(21) Appl. No.: 09/883,193

(22) Filed: Jun. 19, 2001

Related U.S. Application Data
(60) Provisional application No. 60/265,152, filed on Jan. 31, 2001.
(60) Provisional application No. 60/279,112, filed on Mar. 28, 2001.

(51) Int. Cl. G06F 17/60

(52) U.S. Cl. 705/4

(57) ABSTRACT

A system for facilitating interaction with an insurance service includes a processor unit for executing program instructions, a memory for storing the program instructions, and a communication interface for interacting with a user. The system further includes interface logic for providing a graphical interface presentation to the user concerning the insurance service, including at least one of: (a) a first dashboard display for presenting overview information with respect to the renewal of at least one insurance policy; (b) a second dashboard display for presenting overview information with respect to the processing of at least one automatic agreement; (c) a third dashboard display for presenting overview information with respect to the processing of at least one insurance claim; and (d) a fourth dashboard display for presenting executive-level overview information compiled from information presented in the first, second and third dashboard displays. In an exemplary embodiment, the insurance service pertains to a reinsurance service.

### CROSS REFERENCE TO RELATED APPLICATIONS

The present application claims the benefit of U.S. Provisional Application Serial No. 60/265,152, filed on Jan. 31, 2001, which is incorporated by reference herein in its entirety. The present application also claims the benefit of U.S.

Provisional Application Serial No. 60/279,112, filed on Mar. 28, 2001, which is incorporated by reference herein in its entirety.

### BACKGROUND OF THE INVENTION

The present invention generally relates to a system and method for facilitating interaction with a financial service. In a more particular embodiment, the present invention relates to a system and method for facilitating interaction with an electronic insurance service using a dashboard-type display.

The growing acceptance of electronic commerce in the marketplace has resulted in the development of a multitude of computerized financial services (also referred to herein as “on-line services”). For instance, consumers may presently access electronic shopping-related services, bank-related services, investment-related services, insurance-related services, etc. to perform various tasks traditionally performed in manual fashion. In the most common approach, these services are implemented on a network server (or servers) connected to a wide-area network (such as the Internet). Consumers may access these servers via their personal computers (or other electronic access devices) by specifying the respective network addresses associated with these servers.

Many of these on-line services operate by providing a sequence of graphical user interface pages to the user. These pages typically include various navigational mechanisms (such as pull-down menus, hypertext links, etc.) that allow a user to navigate through the pages to perform desired tasks. For instance, the service may provide an introductory page (also referred as a “homepage”) that provides various links to different subpages. The user may select an appropriate subpage by pointing to and clicking on its associated link in the homepage using, for instance, a conventional graphical mouse device.

However, empowering a user with a wealth of network-accessible resources may have the negative consequence of overwhelming the user. For instance, a typical on-line service may provide a large amount of information to its users. Nevertheless, to extract this information, the service may require the user to sequence through many graphical user interface pages, guided by a sometimes complex array of menu options, graphical icon links, and instructions. The user may find this procedure cumbersome, confusing and/or frustrating, especially when the user wishes to quickly access the site to perform a relatively simple task. Further, a complexly structured graphical interface may have the negative consequence of “burying” useful information, so that the user is not sufficiently alerted to critical information and events.

Further, different users may have different roles within a particular financial field, and may thus access the financial service to satisfy different objectives. Many financial services provide the same type of information to all users, and therefore fail to accommodate the unique needs of different classes of users. This characteristic also contributes to the complexity of the financial service as perceived by its users. That is, the display of uniform information to all users may force at least some users to navigate through several pages of superfluous information to locate the informational resources that are relevant to their needs.

Generally, the user-friendliness of an on-line service may directly contribute to its commercial success. Thus, the above-described characteristics of known on-line services may have a negative impact on the revenue generated by the on-line services.

Known on-line services may suffer from additional unspecified deficiencies.

There is accordingly a need for a more effective system and method for interacting with a financial service.

### SUMMARY OF THE INVENTION

The present invention addresses the above-identified needs, as well as additional unspecified needs.

One exemplary aspect of the invention pertains to a system for facilitating interaction with an insurance service. The system includes a processor unit for executing program instructions, a memory, coupled to the processor unit, for storing the program instructions, and a communication interface, also coupled to the processor unit, for interacting with a user. The system further includes interface logic for providing a graphical interface presentation to the user concerning the insurance service, including at least one of: (a) a first dashboard display for presenting overview information with respect to the renewal of at least one insurance policy; (b) a second dashboard display for presenting overview information with respect to the processing of at least one automatic agreement; (c) a third dashboard display for presenting overview information with respect to the processing of at least one insurance claim; and (d) a fourth dashboard display for presenting executive-level overview information compiled from information presented in the first, second and third dashboard displays.

In an exemplary embodiment, the insurance service pertains to a reinsurance service.

Another exemplary aspect of the invention pertains to a system for facilitating interaction with a financial service. The system includes a processor unit for executing program instructions, a memory, coupled to the processor unit, for storing the program instructions, and a communication interface, coupled to the processor unit, for interacting with a user. The system further includes interface logic for providing a graphical interface presentation to the user concerning the financial service including: (a) at least one dashboard display for presenting summary information regarding the financial service; and (b) at least one of the following general fields: (i) a first field that identifies selectable Business Center options, the Business Center options associated with functional modules for performing financial service-related tasks related to a financial field served by the financial service; (ii) a second field that identifies selectable Resource Center options, the Resource Center options associated with educational resources related to the financial field served by the service; and (iii) a third field that identifies selectable Support Center options, the Support Center options associated with resources designed to assist a user in using the financial service.

The above-described systems allow a user to quickly access desired information and/or services. This facilitates the user's interaction with the systems, e.g., by expediting the user's tasks, and/or improving the user's comprehension of relevant information.

Additional features and advantages of the present invention will be apparent from the ensuing description.

### BRIEF DESCRIPTION OF THE DRAWINGS

The present invention can be understood more completely by reading the following Detailed Description of exemplary embodiments, in conjunction with the accompanying drawings, in which:

FIG. 1 shows an exemplary system for implementing the present invention;

FIG. 2 shows an exemplary workstation for interacting with the system of FIG. 1;

FIG. 3 shows an exemplary flowchart for explaining the navigational options provided by a graphical interface presentation used for interacting with an insurance service;

FIGS. 4-9 show exemplary interface presentations for display at the workstation of FIG. 2 pertaining to an insurance service; and

FIG. 10 shows an identification of different exemplary user groups that may access the insurance service according to one exemplary embodiment.

### DETAILED DESCRIPTION OF THE INVENTION

The present invention pertains to an efficient means for providing overview information to users regarding any type of financial service. In one exemplary application, the service pertains to an insurance-related service. In a more specific exemplary application, the service pertains to a reinsurance-related service. As understood in the art, “reinsurance” generally refers to a practice whereby one party, the reinsurer, in consideration of premium paid, agrees to indemnify another party, the reinsured, for part or all of the liability assumed by the reinsured under a policy (or policies) of insurance. More briefly stated, reinsurance is insurance for insurers, used to “spread out” their liability on their issued insurance. For the convenience of the reader, Table 1 at the end of the specification defines various reinsurance-related terms used herein.

The users of the financial service may vary depending on the nature of the financial service. In a typical financial field, an organization (such as a corporation) may have a defined business relationship with the service. For instance, the organization may serve the role of providing, supporting, funding, and/or sponsoring the service, etc. The term “internal users” refers to a class of users directly associated with such an organization. For instance, these individuals may comprise employees of the organization who access the service in the context of their role as service providers. In contrast, the term “external users” refers to a class of users who are not directly associated with the organization. For instance, these individuals may comprise users that access the service as customers of the organization (e.g., to obtain or manage reinsurance for their insurance policy matters).

Internal users may further be divided into “general/superuser” users and “service-specific” users. A general/superuser user may have a general affiliation with the organization that provides the service, but may not use the service on a day-to-day work-related basis. Service-specific users have a more focused work-related interest in the service. For instance, in the field of reinsurance services, a “general/superuser” user may comprise an individual who is associated with a corporation that supports the reinsurance services, but who otherwise does not have a direct day-to-day involvement in the operation of the service (such as an individual having a supervisory, managerial, and/or executive role within the corporation, and who according may prefer to view overview information regarding the service). In contrast, a “service-specific user” does have such direct involvement (such as an individual “in charge” of processing a particular insurance matter or docket of insurance matters, and who accordingly may prefer to view more fine-grained information regarding the service). External users may also be categorized as “general/superuser” or “service-specific” users on the basis of similar criteria. Those having skill in the art will appreciate that other classification schemes may be appropriate for different types of financial services and different types of business environments.

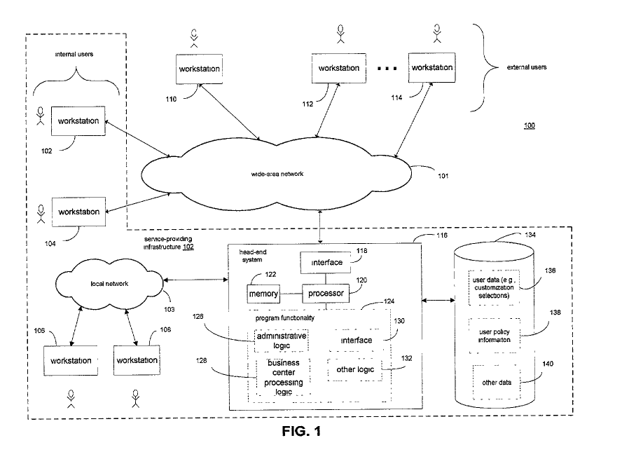

FIG. 1 shows one exemplary system 100 for implementing the invention. It includes a plurality of workstations (e.g., illustrative workstations 102, 104, 106, 108, 110, 112 and 114) coupled to a head-end system 116. In the exemplary scenario of FIG. 1, workstations 102, 104, 106 and 108 are manned by “internal users,” whereas workstations 110, 112 and 114 are manned by “external users.” As defined above, the term “internal users” refers to a class of users directly associated with an organization that provides or supports the financial service. The term “external users” refers to a class of users that are not directly associated with the organization (such as individuals that access the service as external clients of the organization).

In the exemplary embodiment shown in FIG. 1, one or more internal users (such as users operating workstations 102 and 104) may access the head-end system 116 via a network 101 (e.g., the Internet). External users (such as users operating workstations 110, 112, and 114) may also access the head-end system 116 via network 101. Alternatively, one or more internal users (such as users operating workstations 106 and 108) may access the head-end system 116 via a network 103 (e.g., a corporate intranet). Those skilled in the art will appreciate that alternative means can be used to interconnect workstations with the head-end system 116. In any case, users may access the head-end system 116 in a conventional fashion by inputting an address associated with the head-end system 116 using their respective workstations.

The equipment associated with the financial service is generally denoted as infrastructure 102. In the exemplary setting of FIG. 1, this infrastructure 102 includes a number of workstations (e.g., workstations 102, 104, 106, 108), local network equipment (e.g., local-area network 103), head-end system 116, and data storage equipment (e.g., database 134). Those skilled in the art will appreciate that other service providers may employ different equipment to implement the service.

The membership of workstations 102 and 104 in infrastructure 102 need not reflect a fixed allocation of workstations to the infrastructure 102. Rather, any user associated with the service provider may typically commandeer any workstation (such as a personal computer) at any location to access the head-end system 116, thus effectively “assimilating” that workstation into the infrastructure 102. Thus, the depiction of the infrastructure 102 as having defined “borders” corresponds more to the logical organization of the system 100 at a particular point in time.

The head-end system 116 itself may comprise any type of system for implementing the service. For instance, the head-end system 116 may comprise a server-type computer in the context of a client-server architecture. For instance, the head-end system 116 may be implemented using the Microsoft Windows™ NT™, Windows™ 2000, Unix, Linux, Xenix, IBM AIX™, Hewlett-Packard UX™, Novell Netware™, Sun Microsystems Solaris™, OS/2, BeOS™, Mach, Apache, OpenStep™, or other operating system or platform.

In general, the head-end system 116 may include conventional hardware, such as a processor unit 120, a memory 122, and a communication interface 118. The processor unit 120 serves as a primary engine for executing computer instructions to provide the financial service. The memory 122 (such as a Random Access Memory, or RAM) stores instructions and other data for use by the processor unit 120. The communication interface 118 allows the head-end system 116 to communicate with external entities, such as the workstations, via networks 101 or 103 (or some other communication route).

The head-end system 116 includes various program functionality 124 for carrying out the financial service, such as a reinsurance financial service. Such functionality 124 may take the form of machine instructions that perform various routines when executed by the processor unit 120, e.g., at the request of a user. For instance, the functionality 124 may include administrative logic module 126 for handling tasks associated with establishing and administering user accounts. The functionality 124 may further include a Business Center processing logic module 128 for providing one or more modules that perform financial tasks related to the financial application. The functionality 124 may further include an interface logic module 130 for generating an interface presentation including one or more dashboard displays for presentation to users at their respective workstations, and for processing users' selections made while viewing the dashboard displays. Finally, the functionality 124 may include various other logic modules 132 for handling other aspects of the service provided by the head-end system 116. Each logic module (126, 128, 130, 132), in turn, may include a subset of submodules (not shown) for handling various subtasks involved in carrying out the main task provided by the associated logic module.

The database 134 stores data that is relied on by the head-end system 116 in performing its ascribed functions. For instance, the database 134 may store user data 136; this data codifies various information regarding the service's users, such as user customization selections. User customization selections specify the respective informational preferences of users. These selections are accessed by the head-end system 116 to govern the content of information that is displayed to the users. The database 134 may also store user policy data that defines attributes of the insurance matters maintained by the service. Finally, the database 134 may contain various other data 140 pertinent to particular applications.

The database 134 may be implemented using any type of storage media. For instance, it can comprise a hard-drive, RAM memory, magnetic media (e.g., discs, tape), optical media, etc. The database 134 may be implemented as an Oracle™ relational database sold commercially by Oracle Corp. Other database protocols can be used to implement the database, such as Informix™, DB2 (Database 2), Sybase, etc. The database 134 may comprise a unified storage repository located at a single site, or may represent multiple repositories coupled together in distributed fashion.

The networks 101 and 103 may comprise proprietary networks associated with one or more private business entities, such as intranets. Alternatively, the networks 101 and 103 may comprise any type of network having wide accessibility, such as the Internet. In a preferred embodiment, network 101 represents the Internet, and network 103 represents a corporate intranet. The networks 101 and 103 can be physically implemented as one or more hardwired links, and/or one or more wireless links. Exemplary types of networks that can be used include: a PAN (Personal Area Network); a LAN (Local Area Network); a WAN (Wide Area Network), etc. The links used in the networks 101 and 103 may operate using a variety of known network enabling code, such as Hypertext Markup Language (HTML) or Extensible Markup Language (XML), etc.

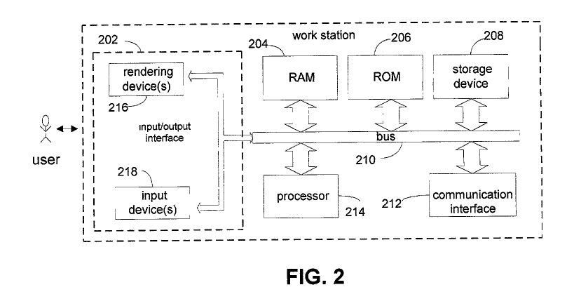

FIG. 2 shows an exemplary workstation for interacting with the system 100 of FIG. 1. The work station generally represents any type of general or special purpose computer including conventional hardware, such as a bus 210 connected to a RAM memory (Random Access Memory) 204, ROM memory (Read-Only Memory) 206, storage device 208, processor 214, and communication interface 212 (which provides access, for instance, to network 110 of FIG. 1). The processor 214 can comprise any type of microprocessor or other logic-executing unit. The storage device 208 may comprise any type of storage media, such as any type of magnetic or optical media (e.g., CDROM). The workstation further includes an input/output interface unit 202. The interface unit 202 may include one or more input devices 218 for use in inputting information to the workstation (e.g., using a keyboard, touch-sensitive panel or screen, speech recognition input, etc.). The interface unit 202 may also include one or more rendering devices 216 for presenting information to a user (e.g., using a display, printer, audio output, etc.). For instance, the rendering device(s) 216 may comprise a display for presenting a dashboard-type display provided by the head-end system 116. The processor 214 may further execute instructions specified by any type of operating system program, such as Microsoft Windows™, etc.

Various other types of workstations or terminals can be used to interact with the system 100. For example, the workstation can be embodied as any type of wireless mobile station (e.g., having Internet browsing capability), a “palm” type of processing device (e.g., a Personal Digital Assistant), etc.

Having described an exemplary architecture for implementing the financial service, discussion will now be directed to the functional aspects of the financial service, e.g., as effectively implemented by the software code represented by functionality 124 of FIG. 1.

The dashboard display technique used by the present invention may be applied to any financial or non-financial service application. To facilitate explanation, section No. 1 below describes the use of the dashboard display technique in the context of reinsurance-related services. Section No. 2 below describes the use of the dashboard technique in the context of other reinsurance applications and other exemplary financial service applications.

By way of overview, the financial service operates by receiving a log-in request from a user (e.g., when a user enters the address of the head-end system 116 using his or her workstation). The head-end system 116 responds by presenting an interface presentation to the user. The interface presentation may include at least one dashboard display for presenting summary information regarding the financial service, as well as one or more other general selectable fields. The dashboard display gives the user a convenient overview of the status of relevant financial information, and may also alert the user to time-critical action items or other information that is deemed “important.” From the dashboard display, the user may then opt to “drill down” to extract further information from the head-end system 116.

1. Application to Reinsurance Services

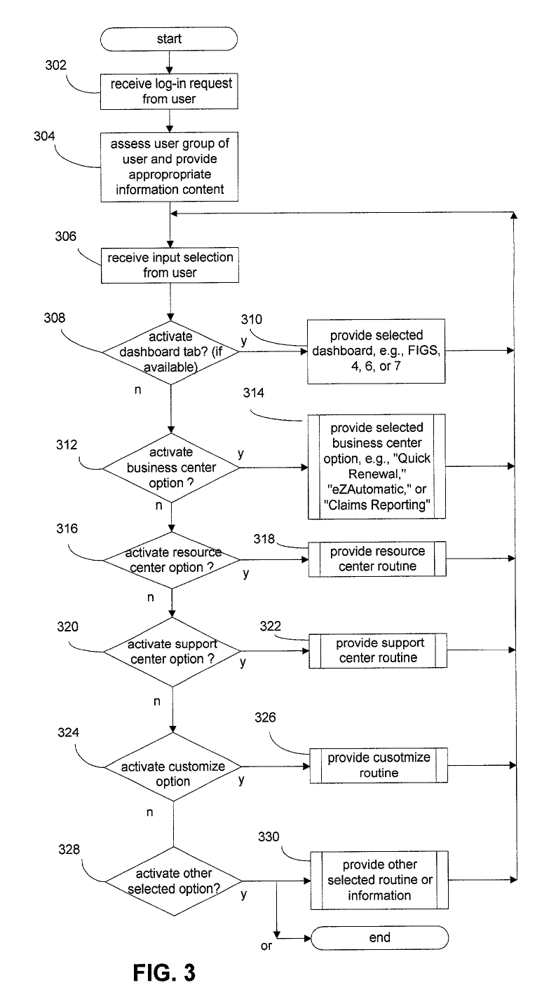

FIG. 3 shows a series actions performed in the delivery of a reinsurance service. In step 302, the head-end system 116 receives a log-in request from a user, e.g., in response to a user inputting a website address associated with the head-end system 116 via his or her personal computer workstation. The head-end system 116 responds in step 304 by determining if the user belongs to a defined class of users. This may be performed by comparing the user's password (or other identifying information) with one or more tables stored in the database 134 to determine whether that password is associated with one or more defined classes. Further, the head-end system 116 determines whether the user has previously specified any user-preference information (e.g., as reflected by user data 138 in database 134), and if so, extracting such preference information. Thereafter, the head-end system 116 displays an introductory interface presentation on the rendering device 216 of the user's workstation (e.g., on the user's graphical display monitor). This interface presentation may contain information that is specifically tailored to suit the user's class affiliation, as well as the user-preference information discussed above.

For instance, consider three users in an exemplary classification scheme. A first user works as an underwriter for a regional office within the service provider's organization. A second user works as a manager on a national level within the service provider's organization. A third user maintains one or more reinsurance policies through the service provider's organization, and thus assumes the role of an “external” customer of the provider's organization. Upon logging on to the service, the head-end system 116 will supply an interface presentation to these users having informational content specifically tailored to their respective identities. For instance, with respect to the first user, the head-end system 116 might furnish overview information pertinent to reinsurance matters handled by the user's regional office. With respect to the second user, the head-end system 116 might furnish overview information pertinent to reinsurance matters handled by all regional offices within the United States (or other inclusive geographic regions). With respect to the third user, the head-end system 116 might furnish overview information that is relevant to only reinsurance matters established and/or handled by that user. In addition to this selective delivery of information, as mentioned above, the head-end system 116 may tailor the information provided in the interface presentation in accordance with the user-preference information previously specified by the user.

The interface presentation provided by the head-end system may contain numerous graphical selection fields (such as various text messages, icons, tabs, etc.). Hypertext links may “underlie” each of these fields. When the user activates a graphical field, the head-end system 116 provides the service or information pertaining to the selected field. Users may select such links in the conventional fashion, e.g., by pointing to and clicking on such links using a graphical mouse-type device. Step 306 indicates that the head-end system 116 has received input from a user, indicating, in turn, that the user has activated one of the graphical selection fields defined above.

In step 308, the head-end system 116 determines whether the user has selected a “dashboard tab.” More specifically, the interface presentation provided by the head-end system 116 may provide multiple dashboard displays, each containing overview information pertaining to a different aspect of the reinsurance service. In one exemplary embodiment, the head-end system 116 provides dashboard displays pertaining to a “Quick Renewal” service, an “eZAutomatic” service, a “claims Reporting” service, and an “Executive” service (all to be described below). The tabs refer to graphical icons which project from the dashboard displays to simulate the tabs which project out in arrayed fashion from a stack of physical file folders.

More specifically, the head-end system 116 may present an initial dashboard display in step 302 (e.g., pertaining to the Quick Renewal service) when a user first logs on to the service. The head-end system 116 may select this initial dashboard display based on preference information specified in the user data 136 within database 134, or, in the absence of such information, according to default rules that govern the operation of the head-end system 116. The head-end system 116 highlights the tab corresponding to the currently presented dashboard display, and displays the other tabs (if they exist for a particular user) in background shading. If a user selects one of the deactivated dashboard displays in step 306, then the head-end system 116 will provide the selected dashboard in step 310 and will correspondingly highlight the tab associated with this dashboard display (while displaying the other tabs in background shading).

Alternatively, as determined in step 312, the user may have selected a graphical field corresponding to a Business Center option. In response to such selection, in step 314, the head-end system 116 provides the requested service.

The Business Center options correspond to the service modules identified above, namely the Quick Renewal, eZAutomatic, and claims Reporting. The Quick Renewal service allows a user to renew “facultative” reinsurance business in on-line fashion. Facultative reinsurance refers to a reinsurance arrangement (e.g., agreement) whereby the reinsurer retains the “faculty” to accept or reject individual risks offered by reinsureds. (This is opposed to “treaty” reinsurance, which imposes general obligations on the contracting parties with respect to some class or classes or business.) A “facultative” arrangement (e.g., agreement) may be binding on the contracting parties for a specified period of time (e.g., a year). Accordingly, the Quick Renewal service allows a user to select and renew such arrangements (e.g., agreements) for an additional period of time (e.g., by extending their duration for another year).

In one embodiment, the head-end system 116 allows users to renew their facultative business using a three-step procedure. In the first step, the head-end system 116 displays a list of policy matters and identifies the renewal statuses of the matters (e.g., authorized, bound, declined, expired, in process, or “to be renewed”). The user may click on a policy number to start the renewal process, or to review its account history. In the second step of the renewal procedure, the head-end system 116 prompts the user to answer a series of questions regarding the selected policy matter (e.g., a series of seven questions). On the basis of the user's answers, the head-end system 116 provides the user with an on-line quote with respect to renewal of the policy matter. In the third step of the renewal procedure, the user receives an on-line authorization and binder with respect to the selected policy matter. (A binder is a preliminary contract which summarizes the terms and conditions of reinsurance coverage). Additional details regarding an exemplary three-step renewal process are described in copending application Ser. No. ______, filed on Mar. 16, 2001, entitled “Online Reinsurance Renewal Method,” which is incorporated herein by reference in its entirety.

The eZAutomatic service allows a user to perform “automatic agreement” processing. As understood in the art, an automatic agreement pertains to a book of business that encompasses a group of policies governed by similar terms and is typically handled in en bloc fashion (such as a book of business pertaining to insurance regarding a particular city's school system). This service particularly allows for cession processing, borderaeu processing, and/or viewing agreement profiles with respect to selected policy matters. Cession processing refers to the ability to enter, amend, update or view individual cession information (a cession refers to a unit of insurance ceded to a reinsurer). Bordereau processing refers to the ability to generate new bordereau processing information or view historical information related thereto (where a “bordereau” refers a report specifying premium and/or loss data for identified risks). The viewing of agreement profile information refers to the ability to highlight key elements of an automatic reinsurance agreement or master certificate.

The claims Reporting service allows a user to report claims to the reinsurer. More specifically, the head-end system 116 may allow a user to enter various types of claims by clicking on and retrieving an appropriate input form. Exemplary forms allow for the entry of a casualty claim, property claim, workers compensation claim, etc. For example, when entering a casualty claim, the head-end system 116 may prompt the user to enter claim number, company name, type of claim (automobile liability, general liability, homeowners, medical malpractice, other umbrella, etc.). The claims Reporting service may also prompt the user to enter information concerning the insured, such as the name of the insured, premium state, policy limits, policy number, policy period, etc. The claims Reporting service may also prompt the user to enter loss information, such as date of loss, date of reported loss to the reinsured, location of loss, facts of loss, etc. The claims Reporting service may also prompt the user to enter information regarding the injury periods or property. The claims Reporting service may further prompt the user to enter information regarding their reserves with respect to bodily injury, property damage, medical etc. (where a “reserve” refers to the amount that an insurer expects to pay on claims made by its insured). Finally, the claims Reporting service requests that the user effectively “sign” and date the claims submission, and then formally submit the claim. The user may additionally track the status of claims processing subsequent to the submission of claims, or simply view previously submitted claims.

Instead of a Business Center option, the user may have selected a graphical field corresponding to a Resource Center option (as determined in step 316). In response, in step 318, the head-end system 116 delivers Resource Center information to the user. The Resource Center provides educational information relating to the reinsurance field, such as articles, white papers, site-sponsored newsletters, etc. In one embodiment, the head-end system 116 may divide such information into the categories of “knowledge topics” (e.g., those informational items of general interest to practitioners in the reinsurance field), “focus topics” (e.g., those informational items focused on one or more key issues in the reinsurance field), and “claims scenarios” (e.g., those informational items that identify exemplary fact-based claims situations that serve as guidance in addressing future cases that have a similar fact pattern). The Resource Center may additionally provide underwriting worksheets, underwriting/loss control products and services, and other products that may be directly used in the day-to-day activities of reinsurance personnel. In one embodiment, a user may customize the information provided by the Resource Center such that it is tailored to his or her particular interests in the reinsurance field.

Alternatively, the user may have selected a graphical field corresponding to a Support Center option (as determined in step 320). In response, in step 322, the head-end system 116 delivers Support Center information to the user. As the name suggests, the Support Center assists the user in using the service provided by the head-end system 116. For example, the Support Center may provide a “contact us” screen which allows a user to enter a specific question regarding the reinsurance service provided by the head-end system 116. The Support Center may further display personnel contacts selected by the user that identify individuals that may be contacted in the course of using the financial service, e.g., to gain assistance with using the service. The Support Center may further display a list of commonly asked questions regarding the reinsurance service provided by the head-end system 116, and corresponding answers thereto. The Support Center may also provide information that is specifically geared toward technical questions that the users may have regarding the service provided by the head-end system 116.

Alternatively, the user may have selected a graphical field corresponding to a customization option (as determined in step 324). In response, in step 326, the head-end system 116 provides a customization service to the user. In this service, the head-end system 116 may prompt the user to enter their Business Center preferences (e.g., whether the user is interested in the Quick Renewal service, the eZAutomatic service, and/or the claims Reporting service, etc.). This service may also prompt the user to enter their Resource Center preferences (e.g., whether the user is interested in information concerning directors and officers, errors and omissions, claims, research and publication, news archives, and/or umbrella-type coverage, etc.). This service may also prompt the user to enter their preferences regarding content and news that they wish to receive (such as news regarding auto liability, general liability, products liability, umbrella coverage, workers compensation, property coverage, errors and omissions, directors and officers, employment practice liability, and/or claims reporting, etc.). This service may also prompt the user to enter their preferences regarding Support Center features that they wish to receive from the head-end system 116 (including the “contact us” feature, reinsurance contact information, frequently asked questions, and/or site help, etc.). By virtue of these features, the customization service also allows a user to tailor the reinsurance service to suit his or her particular specialty, unique perspective, or occupational role within the reinsurance field, thereby excluding or reducing the amount of the irrelevant information that is presented to the user. Those skilled in the art will appreciate that there are other techniques for collecting preference-related information from the users. Further, there are other aspects of the graphical user interface that may be customized by users.

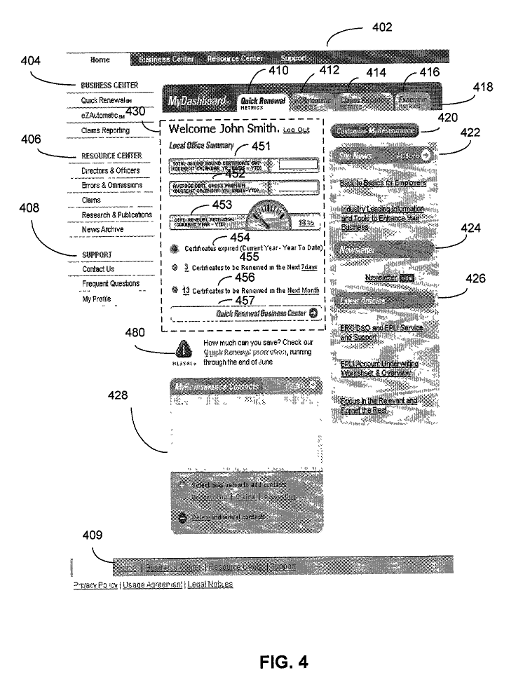

Still alternatively, the user may have selected a graphical field corresponding to some other link provided on the homepage (such as some other link identified below in the discussion of FIG. 4 et seq.) (as determined in step 328). If so, in step 330, the head-end system 116 provides the information or function associated with the selected graphical field. One such “other” option might be a request to log out of a session with the head-end system 116. This terminates the process shown in FIG. 3.

FIGS. 4-8 shows different types of dashboard displays that the head-end system 116 may display at the rendering device 216 of a user's workstation. As described above, the head-end system 116 may provide a different collection of dashboard displays to different users depending on their class affiliation/user group. In the illustrated case, the head-end system 116 has provided access to all of the dashboard displays (namely the Quick Renewal, eZAutomatic, claims Reporting, and Executive dashboard displays), thus providing a “super user combo.” In contrast, the head-end system 116 may grant users an “incomplete” set of these displays (such as one, two or three of the set of four displays) depending on the user's typical field of use of the reinsurance service, as reflected by their class membership status.

Furthermore, as mentioned above, the head-end system 116 may display different informational content in the dashboard displays depending on the users' class affiliations and/or specified preferences. However, the head-end system 116 preferably displays information using a uniform format for all users. More specifically, in one embodiment, the head-end system 116 displays information in the dashboard display using seven fields of information (also referred to as “slots”) regardless of the class affiliation of the users. The use of a standard format facilitates the implementation of the dashboard displays, and may also assist in familiarizing users with the service.

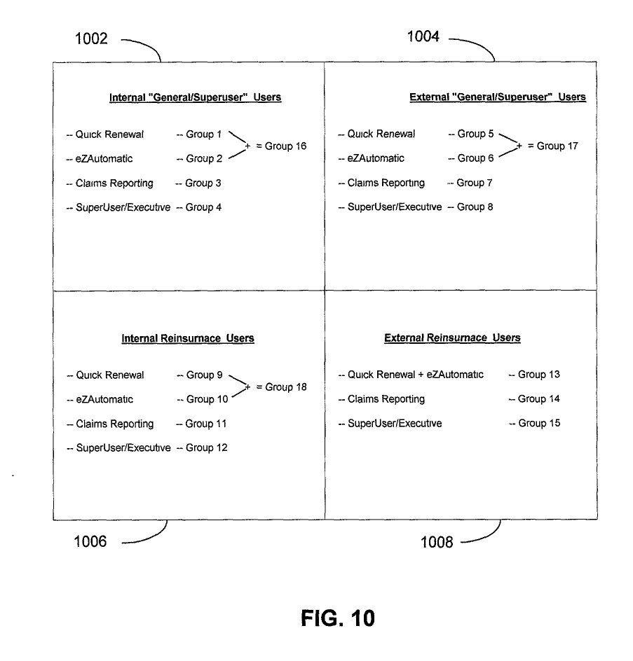

FIG. 10 shows an exemplary organization of users into different user groups. Categories 1002 and 1006 correspond to a subset of “internal” user groups, while categories 1004 and 1008 correspond to “external” user groups. As defined above, internal user groups refer to classes of users directly associated with the service-providing organization (such as employees of the organization, who access the service in the context of their roles as service providers). External user groups refer to classes of users who may use the service as customers of the organization, but who are otherwise not directly associated with the organization. “General/superuser” refers to users (in categories 1002 and 1004) who may have a general affiliation with or interest in the organization which provides the service (such as, in the case of internal users, individuals having a supervisory, managerial, and/or executive role within the organization, and, in the case of external users, individuals who have a similar role within “external” organizations), while service-specific users (such as Reinsurance users in categories 1006 and 1008) may have a more specific day-to-day work-related association with the organization which provides the service (such as individuals who are using the service to process a specific policy matter or docket of policy matters). Those having skill in the art will appreciate that other classifications may be appropriate for different types of financial services and different types of business environments.

As shown in the exemplary case of FIG. 10, users are classified into one or more of 18 user groups. In the category 1002 (internal general/superuser users), members of user group 1 receive only a Quick Renewal dashboard, members of user group 2 receive only an eZAutomatic dashboard display, members of user group 3 receive only a claims Reporting dashboard display, members of user group 4 receive all of the dashboard displays, and members of the combined user group 16 receive both the Quick Renewal and eZAutomatic dashboard displays. In the category 1004 (external general/superuser users), members of user group 5 receive only a Quick Renewal dashboard display, members of user group 6 receive only an eZAutomatic dashboard display, members of user group 7 receive only a claims Reporting dashboard display, members of user group 8 receive all of the dashboard displays, and members of the combined user group 17 receive both Quick Renewal and eZAutomatic dashboard displays. In the category 1006 (external general/superuser users), members of user group 9 receive only a Quick Renewal dashboard display, members of user group 10 receive only an eZAutomatic dashboard display, members of user group 11 receive only a claims Reporting dashboard display, members of user group 12 receive all of the dashboard displays, and members of the combined user group 18 receive both Quick Renewal and eZAutomatic dashboard displays. In the category 1008 (external general/superuser users), members of user group 13 receive only a Quick Renewal dashboard display and an eZAutomatic dashboard display, members of user group 14 receive only a claims Reporting dashboard display, and members of user group 15 receive all of the dashboard displays. Further, as discussed above, the information content provided to users may vary depending on the users' respective group affiliations.

Returning to FIG. 4, this figure shows an interface presentation that provides a dashboard display 430 pertaining to the Quick Renewal service. The seven slots of information in this dashboard display 430 include fields 451-457. Field 451 specifies the total on-line bound certificate Gross Written Premium (GWP) measured from the start of the current calendar year to the current date within that year (or in other words, Year-To-Date, or YTD) (where a certificate comprises short-form documentation of a reinsurance agreement). For example, an external user may have purchased reinsurance from the on-line service for a number of policies. These policies have premiums associated therewith. Field 451 reflects the aggregate of these premiums. Field 452 specifies the average certificate gross premium on a YTD basis. That is, this field 452 reflects the aggregate amount identified in field 451 divided by the number of policy matters issued on-line in the current calendar year.

Field 453 specifies the certificate renewal retention ratio. This field reflects the number of certificates that have been renewed in the current calendar year divided by the number of certificates that the user had the opportunity to renew within the year. The dashboard display 430 presents this information in gauge-type format as well as numeric format.

Field 454 shows the number of certificates that have expired within the current calendar year (up to the current date within the current calendar year). Field 455 shows the number of certificates to be considered for renewal within the next week. And field 456 shows the number of certificates to be considered for renewal within the next month. The dashboard display 430 may present LED-type lights of different colors to demarcate each of the fields 454, 455 and 456, and the criticality associated therewith. Further, the dashboard display 430 may provide hypertext links associated with the numerical information presented for fields 455 and 456. In response to pointing to and clicking on these links, the head-end system 116 provides access to information concerning the reinsurance matters that should be considered for renewal within the indicated timeframes.

Finally, field 457 provides a link to the Quick Renewal Business Center. In other words, this field provides access to a series of interface pages that a user may use to perform the Quick Renewal operation, such as a series of interface pages for performing the three-step procedure identified above.

As noted above, the head-end system 116 may fill in the slots 451-456 differently depending on the identity of the user that accesses the service. For example, for an external user (such as an underwriter of an insurance company), the head-end system 116 may present a summary of only those reinsurance matters in the external user's reinsurance portfolio. For an internal user associated with a regional branch office, the head-end system 116 may present a summary of all reinsurance matters handled by that particular branch office. That is, supposing that an Atlanta branch office handles reinsurance matters for 100 external customers. In that case, the head-end system 116 presents aggregate summary information for those 100 customers. For an internal user associated with the service on a national level, the head-end system 116 may present a master summary of all reinsurance matters handled by the service. Still other bases for providing summary information are possible to suit the requirements of different financial applications and business environments.

As mentioned, FIG. 4 shows that field 457 provides a link to an appropriate Business Center (e.g., the Quick Renewal service). This is appropriate for selected classes of users (such as external underwriter users). For other users (such as internal managers and executives), the head-end system 116 may present a link to a page containing statistics regarding the reinsurance service.

The Quick Renewal dashboard display also includes a highlighted tab 410 within a tab bar 418. Other tabs in this bar 418 include an eZAutomatic tab 412, a claims Reporting tab 414, and an Executive tab 416. These tabs are displayed with background shading to indicate that they are not currently active. Selection of one of the currently non-activated tabs causes its corresponding dashboard information to be displayed instead of the currently active Quick Renewal dashboard information 430.

The interface page shown in FIG. 4 also includes other display fields. These fields include an overhead menu bar selection field 402, and a corresponding bottom-screen menu bar 409. These fields permits a user to select between a main homepage, Business Center page, Resource Center page, or Support Center page. Along the left-end side, this screen includes a Business Center selection field 404 (which permits the user to click on and select the Quick Renewal service, eZAutomatic service, and claims Renewal service), a Resource Center field 406 (which allows a user to select among resource topics such as Directors & Officers, Errors & Omissions, claims, Research & Publications, and News Archives), and a Support Center field 408 (which permits a user to select among a “Contact Us” feature, a Frequent Questions feature, and a MyProfile feature). Along the right-hand side, this screen includes a Site News field 422, a Newsletter field 424, and a Latest Articles field 426.

The screen further includes a bottom-located MyReinsurance Contacts field 428. This field identifies personnel that the user may choose to contact in the course of interacting with the reinsurance service. In one exemplary embodiment, the user may select the group of contact personnel when customizing their interface. In another embodiment, the head-end system may entirely or partially pre-populate this field with contact personnel appropriate to the user's classification.

The screen further includes a promotion field 480. Activation of this field prompts the head-end system 116 to provide advertising information describing one or more opportunities pertaining to the reinsurance service that the user may want to consider. The system provider may tailor this advertising information to suit various marketing objectives appropriate to the financial and business context in which this service is employed. Further, the system provider may tailor this advertising information to particularly suit different classes of users, and/or may allow the user to customize the interface to provide only certain kinds of advertising information.

Finally, screen includes a Customize MyReinsurance icon 420 that permits a user to customize the graphical interface in the manner described above. For instance, this icon 420 may be activated to allow the user to specify his or her preference regarding the initial dashboard display that is displayed upon logging on to the site, the type of news that is presented (and excluded), etc.

Those skilled in the art will appreciate that the graphical arrangement of fields in FIG. 4 is exemplary, and that other reinsurance providers may opt to arrange this information using a different layout. Further, other reinsurance providers may opt to provide a different selection of information than is shown in FIG. 4 (e.g., by omitting certain information fields, and adding other information fields).

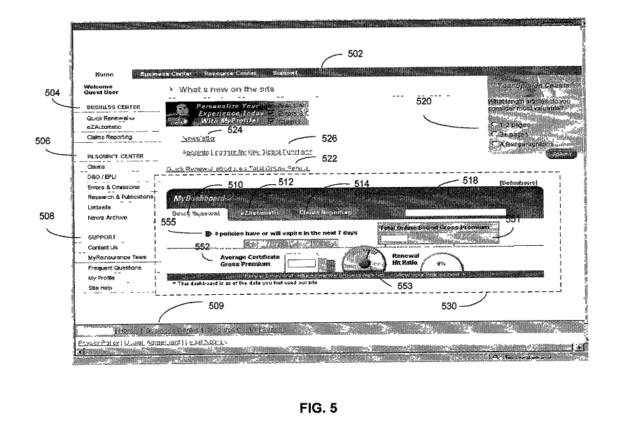

For example, FIG. 5 shows one alternative manner of displaying Quick Renewal dashboard display information. This presentation includes an overhead menu bar 502, bottom-positioned menu bar 509, Business Center selection field 504, Resource Center selection field 506, Support Center selection field 508, Customization selection field 520, Newsletter selection field 524, Articles selection field 526, and a Site News selection field 522. This interface presentation further includes a tab display bar 518 including a Quick Renewal tab 510, an eZAutomatic tab 512, and a claims Reporting tab 514. This presentation further includes an indication of total on-line bound gross premium 551, an indication of average certificate gross premium 552, a renewal hit ratio 553, and an indication of the number of policies that will expire in the next seven days 555. These fields have the same functionality as their same-named counterparts discussed above in the context of FIG. 4. Those skilled in the art will appreciate that still other graphical arrangements of reinsurance information are possible.

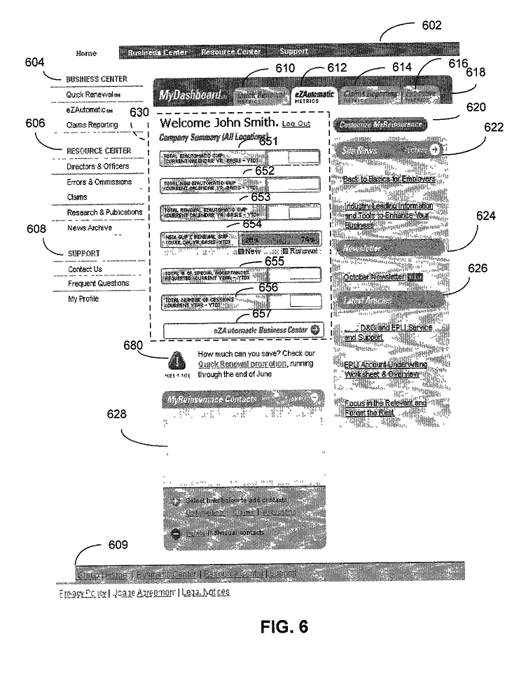

FIG. 6 shows an interface screen that provides a dashboard display 630 pertaining to the eZAutomatic service. The seven slots of information in this dashboard display include fields 651-657. To begin with, field 651 shows the total eZAutomatic Gross Written Premium (GWP) for a collection of reinsurance matters established in on-line fashion. This field 651 reflects the aggregate of premiums reported on bordereaux on a YTD basis.

Field 652 presents the total new eZAutomatic Gross Written Premium on a YTD basis, and field 653 presents total renewal eZAutomatic Gross Written Premium on a YTD basis. For example, suppose that the value presented in the first field 651 is $100,000, 30% of which reflects newly established resinsurance business and 70% reflects renewal reinsurance business. In that case, field 652 would list $30,000 and field 653 would list $70,000. Field 654 presents the same information in percentage format; namely this field 654 displays an indication of 30% new GWP and 70% renewal GWP.

Field 655 indicates the total number of special acceptances granted on reinsurance business on a YTD basis (where a “special acceptance” refers to a separate addendum to a reinsurance agreement which supplies a provision that is not automatically covered by the reinsurance agreement in its unmodified form). This field 655 reflects how often users requested deviation from the terms of an automatic agreement. A high number in this field may suggest that the reinsurance program may not be optimally suited to the needs of the users, and thus may warrant retooling (e.g., by changing the terms of the automatic agreement).

Field 656 provides an indication of the total number of cessions issued on a YTD basis. A cession refers to a unit of insurance ceded to a reinsurer.

For selected classes of users, field 657 provides a link to the eZAutomatic Business Center. For other users, such as internal managerial and executive users, this field provides a link to a functional module that provides statistics regarding the service. Further, as noted above, the head-end system 116 may fill different information into slots 651-656 depending on the identities (and class memberships) of users that accesses the service.

The eZAutomatic dashboard display also includes a highlighted tab 612 within a tab bar 618. Other tabs in this bar 618 include a Quick Renewal tab 610, a claims Reporting tab 614, and an Executive tab 616. These tabs are displayed with background shading to indicate that they are not currently active. Selection of one of the currently non-activated tabs causes its corresponding dashboard information to be displayed instead of the currently active eZAutomatic Renewal dashboard information 630.

The interface presentation shown in FIG. 6 also includes other display fields. These other fields generally correspond to the like-named fields described with reference to FIG. 4. More specifically, these fields include an overhead menu bar selection field 602, a corresponding bottom-screen menu bar 609, a Business Center selection field 604, a Resource Center field 606, a Support Center field 608, a Site News field 622, a Newsletter field 624, a Latest Articles field 626, a bottom-located MyReinsurance Contacts field 628, a promotion field 680, and a Customize MyReinsurance icon 620.

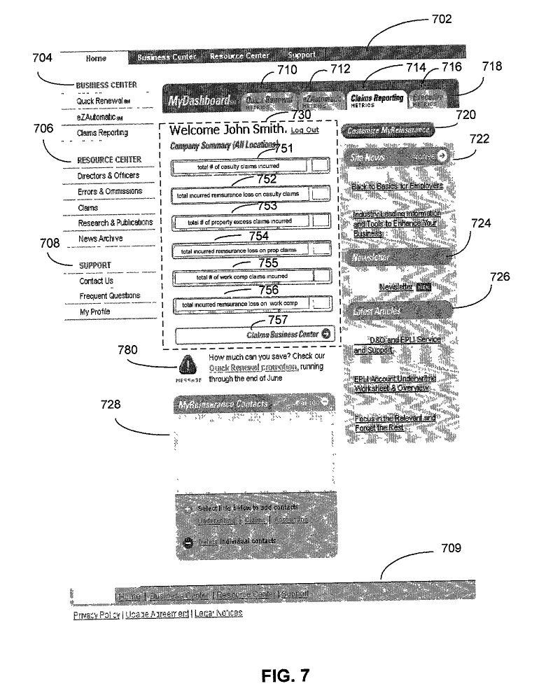

FIG. 7 shows an interface presentation that provides a dashboard display 730 pertaining to the claims Reporting service. The seven slots of information in this dashboard display include fields 751-757. To begin with, field 751 shows the total number of casualty claims incurred on a YTD basis, while field 752 presents an indication of total incurred reinsurance loss on the casualty claims. Field 753 shows the total number of property-related excess claims incurred on a YTD basis, while field 754 presents an indication of total incurred reinsurance loss on the property claims. Field 755 shows the total number of workmans compensation claims incurred on a YTD basis, while field 756 presents an indication of total incurred reinsurance loss on the workmans compensation claims.

Once again, for selected classes of users, field 757 provides a link to the claims Reporting Business Center. For other users, such as internal managerial and executive users, this field provides a link to a functional module that provides statistics regarding the service. Further, as noted above, the head-end system may fill different information into the slots 751-756 depending on the identities and class memberships of different users.

The claims Reporting dashboard display also includes a highlighted tab 714 within a tab bar 718. Other tabs in this bar 718 include Quick Renewal tab 710, an eZAutomatic tab 712, and an Executive tab 716. These tabs are displayed with background shading to indicate that they are not currently active. Selection of one of the currently non-activated tabs causes its corresponding dashboard information to be displayed instead of the currently active claims Reporting dashboard display.

The interface page shown in FIG. 7 also includes other display fields. These other fields generally correspond to the like-named fields described with reference to FIG. 4. More specifically, these fields include an overhead menu bar selection field 702, a corresponding bottom-screen menu bar 709, a Business Center selection field 704, a Resource Center field 706, a Support Center field 708, a Site News field 722, a Newsletter field 724, a Latest Articles field 726, a bottom-located MyReinsurance Contacts field 728, a promotion field 780, and a Customize MyReinsurance icon 720.

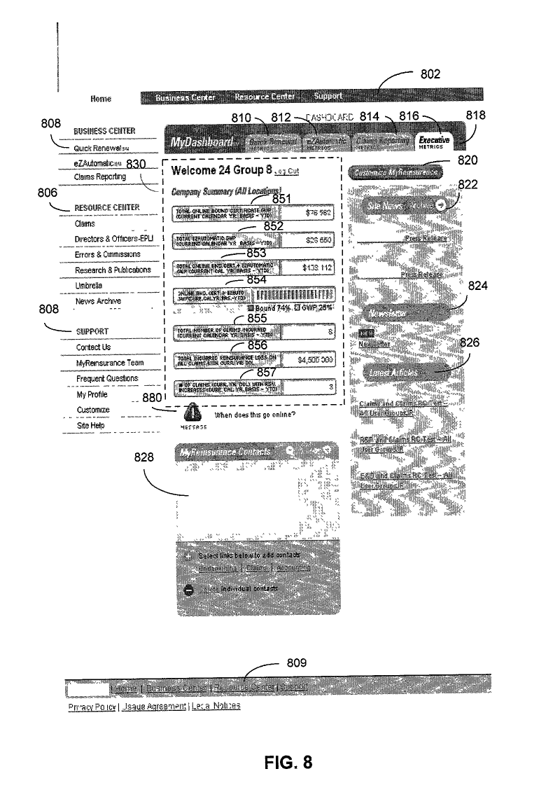

FIG. 8 shows an interface screen that provides a dashboard display 830 pertaining to the Executive reporting service. The seven slots of information in this dashboard display include fields 851-857. Generally, these fields represent a sampling and compilation of information extracted from the Quick Renewal, eZAutomatic, and claims Reporting dashboard displays.

More specifically, field 851 shows the total on-line bound certificate Gross Written Premium (GWP) on a YTD basis. Field 852 shows total eZAutomatic Gross Written Premium (GWP) on a YTD basis. Field 853 shows the aggregates of fields 851 and 852, namely the aggregate of total on-line GWP and total eZAutomatic GWP on a YTD basis. Field 854 graphically and numerically shows the percentage of field 853 that is attributed to on-line bound certificate GWP, and the percentage of field 853 that is attributed to eZAutomatic GWP.

Field 855 shows the total number of claims incurred on a YTD basis. Field 856 shows the total incurred reinsurance loss on all claims on a YTD basis. And finally, field 857 shows the number of claims with reserve increases on a current YTD basis.

The Executive Reporting dashboard display also includes a highlighted tab 816 within a tab bar 818. Other tabs in this bar 818 include a Quick Renewal tab 810, an eZAutomatic tab 812, and a claims Reporting tab 814. These tabs are displayed with background shading to indicate that they are not currently active. Selection of one of the currently non-activated tabs causes its corresponding dashboard information to be displayed instead of the currently active Executive tab 816.

The interface page shown in FIG. 8 also includes other display fields. These other fields generally correspond to the like-named fields described with reference to FIG. 4. More specifically, these fields include an overhead menu bar selection field 802, a corresponding bottom-screen menu bar 809, a Business Center selection field 804, a Resource Center field 806, a Support Center field 808, a Site News field 822, a Newsletter field 824, a Latest Articles field 826, a bottom-located MyReinsurance Contacts field 828, a promotion field 880, and a Customize MyReinsurance icon 820.

2. Application to Other Services

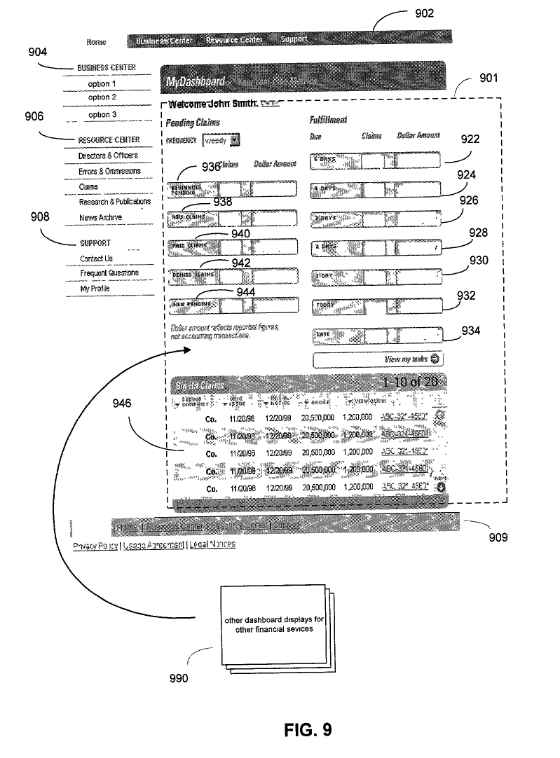

The dashboard interface design concept described above is applicable to other reinsurance applications, other financial applications, and other non-financial applications. For instance, FIG. 9 shows an interface presentation that provides a dashboard display 901 that presents metrics corresponding to a life insurance/reinsurance service. More specifically, this dashboard display 901 includes metrics that pertain to claims submitted by reinsureds regarding life insurance policies. In an exemplary application, reinsurance personnel may use the interface presentation to manage their handling of these claims.

Generally speaking, the dashboard display 901 uses a “waterfall approach” to provide information regarding the handling of claims with respect to selected intervals of time. More specifically, the “FREQUENCY” field in the upper left corner of display 901 allows a user to select an interval of time (such as weekly, monthly, yearly, or other interval of time). The interface logic responds by presenting various metrics concerning claims activity appropriate to the selected interval of time. For instance, field 936 (“beginning pending”) provides the number and aggregate dollar amount of pending claims at the commencement of the current frequency interval (e.g., in one case, one week ago). Field 938 (“new claims”) presents the number and dollar amount of claims that have been registered in the current frequency interval (e.g., in one case, in the last week). Field 940 (“paid claims”) presents the number and dollar amount of claims that have been paid in the current frequency interval (e.g., in one case, in the last week). Field 942 (“denied claims”) presents the number and dollar amount of claims that have been denied in the current frequency interval (e.g., in one case, in the last week). Field 944 (“new pending”) presents the number and dollar amount of claims pending as of a current point in time.

Another series of “fulfillment” fields present information that alerts claims processing personnel of their upcoming claims processing workload. Namely, the fulfillment fields include fields 922, 924, 926, 928 and 930 that specify the numbers and aggregate dollar amounts of claims that are due to be processed (e.g., paid) within the next five days, four days, three days, two days, and one day, respectively. Field 932 specifies the number and dollar amount of claims due to be processed (e.g., paid) on the present day (where the “present day” refers to the day that the user accesses the service). Field 934 shows the number and dollar amount of claims that have processing due dates in the past, and are accordingly denoted as past due.

Finally, field 946 presents information regarding “big hit claims.” As the name suggests, this field presents information regarding claims that are regarded as “large” (i.e., above a prescribed dollar-amount threshold). For example, in one embodiment, field 946 presents information regarding claims that have dollar amounts above $500,000.

Further, as mentioned above in section No. 1, the information presented in the above-identified fields may vary depending on the group affiliation of the user accessing the service. That is, the information presented in the above-identified fields may reflect aggregate information for the organization as a whole, a particular division within the organization, a team within the organization, or one or more separate individuals, etc.

FIG. 9 includes other navigational fields that are similar to the fields discussed in the context of FIGS. 4-8. For instance, the interface presentation includes an overhead menu bar selection field 902, a corresponding bottom-screen menu bar 909, a Business Center selection field 904, a Resource Center field 906, a Support Center field 908, etc. Although not shown, this interface presentation may also display other fields of information discussed in the context of FIGS. 4-8.

Moreover, as indicated in FIG. 9, other dashboard displays (generally denoted as dashboard displays 990) may be substituted into the interface presentation in place of dashboard display 901 to suit other applications provided by the head-end system 116. In this case, the interface presentation may retain some of the general fields identified above, including, for example, the Business Center field 904, Resource Center field 906, and Support Center field 908, etc. The use of this common layout is advantageous because it provides a uniform look and feel to various interface presentations provided by the organization. By virtue of such uniformity, a user who gains familiarity with one type of interface more easily master new application interfaces provided by the organization.

In conclusion, the display of salient information in these dashboard-type displays quickly apprises the user of relevant information. The user may then “drill down” to access further information and/or services relevant to the information presented on the dashboard-type display. This has the potential benefit of expediting a user's search. Further, the dashboard-type displays may facilitate a user's understanding of relevant information, and allow the user to take appropriate steps regarding business matters in a timely fashion. Further, the dashboard displays are tailored to suit the unique needs of different user groups. This further contributes to streamlining and facilitating a user's session with the financial service. Still further benefits are provided by the above-described system and method, as will be appreciated by those skilled in the art.

TABLE 1
Reinsurance Glossary

| term | definition |
|---|---|
| automatic | An automatic agreement pertains to a book of business |
| agreement | that encompasses a group of policies governed by similar |
| | terms and is typically handled in en bloc fashion (such |
| | as, for example, a book of business pertaining to |
| | insurance regarding a particular city's school system). |
| binder | A binder is a preliminary contract which summarizes the |
| | terms and conditions of reinsurance coverage, and is |
| | signed by an accepting underwriter. The issuance of a |
| | formal contract replaces the binder. |
| bordereau | A bordereau is a report specifying premium and/or loss |
| | data for identified risks. This report is submitted by |
| | the reinsured to the reinsurer for certain types of |
| | reinsurance arrangements (e.g., agreements). |
| cedant | A cedant is an insurer that underwrites an insurance |
| | policy to an insured, and thereafter transfers (cedes) |
| | a portion of the risk under that policy to a reinsurer. |
| certificate of | A certificate comprises short-form documentation of a |
| reinsurance | reinsurance arrangement (e.g.. agreement). |
| cession | A cession refers to a unit of insurance ceded to a |
| | reinsurer. |
| errors and | An error and omissions clause stipulates that errors and |
| omissions | omissions pertaining to the reinsurance arrangement |
| clause | (e.g., agreement) will not alter the liability |
| | obligations set forth in the arrangement. |
| facultative | Facultative reinsurance refers to a reinsurance |
| reinsurance | arrangement (e.g., agreement) whereby the reinsurer |
| | retains the “faculty” to accept or reject |
| | individual risks offered by reinsureds. In this |
| | arrangement, the reinsurer and the reinsured may |
| | negotiate over individual risks in insurance |
| | policies. |
| facultative | A facultative certificate refers to a document that |
| certificate | memorializes a facultative cession. |
| premium | A premium is money paid in insurance or reinsurance |
| | contacts as consideration for these contracts |
| reserve | A reserve refers to the amount that an insurer expects |
| | to pay on claims made by its insured. |
| reinsurance | Reinsurance refers to a contractual arrangement |
| | (e.g., agreement) whereby one party (the reinsured) |
| | transfers its insurance liability to another party |
| | (the reinsurer) for paid consideration. |
| reinsured | A reinsured is a party that has transferred (ceded) |
| | insurance risks to another party (i.e., the reinsurer). |
| reinsurer | A reinsurer party is a party that accepts transferred |
| | insurance risks from another party (i.e., the reinsured). |
| special | A special acceptance refers to a separate addendum |
| acceptance | to a reinsurance agreement which supplies a provision |
| | that is not automatically covered by the reinsurance |
| | agreement in its unmodified form. Such a provision may |
| | be the result of separate negotiation between the reinsurer |
| | and the reinsured. |
| treaty | Treaty reinsurance refers to a general reinsurance |
| reinsurance | agreement which imposes general obligations on the |
| | ceding party and the reinsurer with respect to some class |
| | or classes of business (in contrast to facultative |
| | reinsurance which imposes obligations with respect |
| | to specified individual risks). |
| Year-To- | A Year-To-Date value is measured from the start of |
| Date, or YTD | the current calendar year to the current date |
| basis | within that year. |

Other modifications and variations to the embodiments described above can be made without departing from the spirit and scope of the invention, as is intended to be encompassed by the following claims and their legal equivalents.

What is claimed is:

1. A system for facilitating interaction with an insurance service, comprising:
a processor unit for executing program instructions;
a memory, coupled to the processor unit, for storing the program instructions;
a communication interface, coupled to the processor unit, for interacting with a user; and
interface logic for providing a graphical interface presentation to the user concerning the insurance service, including at least one of:
(a) a first dashboard display for presenting overview information with respect to the renewal of at least one insurance policy;
(b) a second dashboard display for presenting overview information with respect to the processing of at least one automatic agreement;
(c) a third dashboard display for presenting overview information with respect to the processing of at least one insurance claim; and
(d) a fourth dashboard display for presenting executive-level overview information compiled from information presented in the first, second and third dashboard displays.

2. The system of claim 1, wherein the insurance service comprises a reinsurance service.

3. The system of claim 1, wherein the interface logic includes at least two of the first through fourth dashboard displays.

4. The system of claim 1, wherein the first dashboard display includes at least one of the following fields of information:
a first field that specifies total on-line bound certificate gross written premium measured on a year-to-date basis;
a second field that specifies average certificate gross premium on a year-to-date basis;
a third field that specifies certificate renewal retention ratio on a year-to-date basis;
a fourth field that specifies the number of certificates that have expired within the current calendar year on a year-to-date basis;
a fifth field that specifies the number of certificates to be considered for renewal within a next week;
a sixth field that specifies the number of certificates to be considered for renewal within a next month; and
a seventh field that provides a link to additional resources pertaining to the insurance service.

5. The system of claim 4, wherein the first dashboard display includes all of the first through seventh fields.

6. The system of claim 1, wherein the second dashboard display includes at least one of the following fields of information:
a first field that specifies total gross written premium for automatic reinsurance matters on a year-to-date basis;
a second field that specifies total new automatic gross written premium on a year-to-date basis;
a third field that specifies total renewal automatic gross written premium on a year-to-date basis;
a fourth field that specifies new and renewal automatic gross written premium in percentage format on a year-to-date basis;
a fifth field that specifies total number of special acceptances granted on reinsurance business on a year-to-date basis;
a sixth field that provides an indication of total number of cessions issued on a year-to-date basis; and
a seventh field that provides a link to other resources pertaining to the insurance service.

7. The system of claim 6, wherein the second dashboard displays includes all of the first through seventh fields.

8. The system of claim 1, wherein the third dashboard display includes at least one of the following fields of information:
a first field that specifies total number of casualty claims incurred on a year-to-date basis;
a second field that specifies total incurred reinsurance loss on the casualty claims;
a third field that specifies total number of property-related excess claims incurred on a year-to-date basis;
a fourth field that specifies total incurred reinsurance loss on the property claims;
a fifth field that specifies total number of workmans compensation claims incurred on a year-to-date basis;
a sixth field that specifies total incurred reinsurance loss on the workmans compensation claims; and
a seventh field that provides a link to other resource pertaining to the insurance service.

9. The system of claim 8, wherein the third dashboard displays includes all of the first through seventh fields.

10. The system of claim 1, wherein the fourth dashboard display includes at least one of the following fields of information:
a first field that specifies total on-line bound certificate gross written premium on a year-to-date basis;
a second field that specifies total automatic gross written premium on a year-to-date-basis;
a third field that specifies the aggregate of the first and second fields;
a fourth field that specifies the percentage of the third field that is attributed to the first field, and the percentage of the third field that is attributed to the second field;
a fifth field that specifies total number of claims incurred on a year-to-date basis;
a sixth field that specifies total incurred reinsurance loss on claims on a year-to-date basis; and
a seventh field that specifies number of claims with reserve increases on a current year-to-date basis.

11. The system of claim 10, wherein the fourth dashboard displays includes all of the first through seventh fields.

12. The system of claim 1, wherein the interface logic additionally includes at least one of the following general fields:
a first field that identifies selectable Business Center options, the Business Center options associated with functional modules for performing insurance service-related tasks related to the insurance field served by the insurance service;
a second field that identifies selectable Resource Center options, the Resource Center options associated with educational resources related to the insurance field served by the insurance service;
a third field that identifies selectable Support Center options, the Support Center options associated with resources designed to assist a user in using the insurance service;
a fourth field that identifies a selectable customization option, the customization option associated with a customization function that allows a user to customize at least one feature of the interface presentation presented by the interface logic; and
a fifth field that identifies contact information, the contact information identifying personnel that may be of use to the user in performing insurance-related tasks.

13. The system of claim 12, wherein the interface logic includes the first through fifth general fields.

14. The system of claim 1, further including a database that identifies a user group assigned to the user, and wherein the interface logic includes logic for selecting information for display in the at least one dashboard display based on the user's assigned group.

15. A system for facilitating interaction with a financial service, comprising:
a processor unit for executing program instructions;
a memory, coupled to the processor unit, for storing the program instructions;
a communication interface, coupled to the processor unit, for interacting with a user; and
interface logic for presenting a graphical interface presentation to the user concerning the financial service including:
at least one dashboard display for presenting summary information regarding the financial service;
at least one of the following general fields:
a first field that identifies selectable Business Center options, the Business Center options associated with functional modules for performing financial service-related tasks related to a financial field served by the financial service;
a second field that identifies selectable Resource Center options, the Resource Center options associated with educational resources related to the financial field served by the service; and
a third field that identifies selectable Support Center options, the Support Center options associated with resources designed to assist a user in using the financial service.

16. The system of claim 15, wherein the interface logic includes the first through third general fields.

17. A computer-readable medium for providing instructions to processing logic for facilitating interaction with an insurance service, comprising:
interface logic for providing a graphical interface presentation to the user concerning the insurance service, including at least one of:
(a) a first dashboard display for presenting overview information with respect to the renewal of at least one insurance policy;
(b) a second dashboard display for presenting overview information with respect to the processing of at least one automatic agreement;
(c) a third dashboard display for presenting overview information with respect to the processing of at least one insurance claim; and
(d) a fourth dashboard display for presenting executive-level overview information compiled from information presented in the first, second and third dashboard displays.

18. The computer readable medium of claim 17, wherein the interface logic includes at least two of the first through fourth dashboard displays.

19. The computer readable medium of claim 17, wherein the interface logic further includes at least one of the following general fields:
a first field that identifies selectable Business Center options, the Business Center options associated with functional modules for performing insurance service-related tasks related to the insurance field served by the insurance service;
a second field that identifies selectable Resource Center options, the Resource Center options associated with educational resources related to the insurance field served by the insurance service;
a third field that identifies selectable Support Center options, the Support Center options associated with resources designed to assist a user in using the insurance service;
a fourth field that identifies a selectable customization option, the customization option associated with a customization function that allows a user to customize at least one feature of at least one dashboard display presented by the interface logic; and
a fifth field that identifies contact information, the contact information identifying personnel that may be of use to the user in performing insurance-related tasks.

20. A method for facilitating interaction with an insurance service, comprising:
receiving a request from a user to access the insurance service; and
providing a graphical interface presentation to the user, the interface presentation including at least one of:
(a) a first dashboard display for presenting overview information with respect to the renewal of at least one insurance policy;
(b) a second dashboard display for presenting overview information with respect to the processing of at least one automatic agreement;
(c) a third dashboard display for presenting overview information with respect to the processing of at least one insurance claim; and
(d) a fourth dashboard display for presenting executive-level overview information compiled from information presented in the first, second and third dashboard displays.

21. The method of claim 20, wherein the insurance service comprises a reinsurance service.

22. The method of claim 20, wherein the interface presentation includes at least two of the first through fourth dashboard displays.

23. The method of claim 20, wherein the first dashboard display includes at least one of the following fields of information:
a first field that specifies total on-line bound certificate gross written premium measured on a year-to-date basis;
a second field that specifies average certificate gross premium on a year-to-date basis;
a third field that specifies certificate renewal retention ratio on a year-to-date basis;
a fourth field that specifies number of certificates that have expired within the current calendar year on a year-to-date basis;
a fifth field that specifies number of certificates to be considered for renewal within a next week;
a sixth field that specifies number of certificates to be considered for renewal within a next month; and
a seventh field that provides a link to additional resources pertaining to the insurance service.

24. The method system of claim 23, wherein the first dashboard display includes all of the first through seventh fields.

25. The method of claim 20, wherein the second dashboard display includes at least one of the following fields of information:
a first field that specifies total gross written premium for a collection of automatic-type reinsurance matters on a year-to-date basis;
a second field that specifies total new automatic gross written premium on a year-to-date basis;
a third field that specifies total renewal automatic gross written premium on a year-to-date basis;
a fourth field that specifies new and renewal automatic gross written premium in percentage format on a year-to-date basis;
a fifth field that specifies total number of special acceptances granted on reinsurance business on a year-to-date basis;
a sixth field that provides an indication of total number of cessions issued on a year-to-date basis; and
a seventh field that provides a link to additional resources pertaining to the insurance service.

26. The method of claim 25, wherein the second dashboard display includes all of the first through seventh fields.

27. The method of claim 20, wherein the third dashboard display includes at least one of the following fields of information:
a first field that specifies total number of casualty claims incurred on a year-to-date basis;
a second field that specifies total incurred reinsurance loss on the casualty claims;
a third field that specifies total number of property-related excess claims incurred on a year-to-date basis;
a fourth field that specifies total incurred reinsurance loss on the property claims;
a fifth field that specifies total number of workmans compensation claims incurred on a year-to-date basis;
a sixth field that specifies total incurred reinsurance loss on the workmans compensation claims; and
a seventh field that provides a link to other resource pertaining to the insurance service.

28. The method of claim 27, wherein the third dashboard display includes all of the first through seventh fields.

29. The method of claim 20, wherein the fourth dashboard display includes at least one of the following fields of information:
a first field that specifies total on-line bound certificate gross written premium (GWP) on a year-to-date basis;
a second field that specifies total automatic gross written premium on a year-to-date-basis;
a third field that specifies the aggregate of the first and second fields;
a fourth field that specifies the percentage of the third field that is attributed to the first field, and the percentage of the third field that is attributed to the second field;
a fifth field that specifies total number of claims incurred on a year-to-date basis;
a sixth field that specifies total incurred reinsurance loss on claims on a year-to-date basis; and
a seventh field that specifies number of claims with reserve increases on a current year-to-date basis.

30. The method of claim 29, wherein the fourth dashboard displays includes all of the first through seventh fields.

31. The method of claim 20, wherein the interface presentation additionally includes at least one of the following general fields:
a first field that identifies selectable Business Center options, the Business Center options associated with functional modules for performing insurance service-related tasks related to the insurance field served by the insurance service;
a second field that identifies selectable Resource Center options, the Resource Center options associated with educational resources related to the insurance field served by the insurance service;
a third field that identifies selectable Support Center options, the Support Center options associated with resources designed to assist a user in using the insurance service;
a fourth field that identifies a selectable customization option, the customization option associated with a customization function that allows a user to customize at least one feature of the interface presentation presented by the interface logic; and
a fifth field that identifies contact information, the contact information identifying personnel that may be of use to the user in performing insurance-related tasks.

32. The method of claim 31, wherein the interface presentation includes the first through fifth general fields.

33. The method of claim 20, further including a step of maintaining a database that identifies a user group assigned to the user, and wherein the step of providing a graphical interface presentation to the user comprises the steps of accessing the database to determine the user group assigned to the user, and then providing the at least one dashboard display based on the user's assigned group.

34. A method for facilitating interaction with a financial service, comprising:
receiving a request from a user to access the financial service; and
providing a graphical interface presentation to the user, the interface presentation including:
at least one dashboard display for presenting summary information regarding the financial service;
at least one of the following general fields:
a first field that identifies selectable Business Center options, the Business Center options associated with functional modules for performing financial service-related tasks related to a financial field served by the financial service;
a second field that identifies selectable Resource Center options, the Resource Center options associated with educational resources related to the financial field served by the service; and
a third field that identifies selectable Support Center options, the Support Center options associated with resources designed to assist a user in using the financial service.

35. The method of claim 34, wherein the interface logic includes the first through fifth general fields.

36. A computer signal readable by a computing system and encoding a computer program of instructions for executing a computer process performing the method recited in claim 20.

37. A computer signal readable by a computing system and encoding a computer program of instructions for executing a computer process performing the method recited in claim 34.
